(19) United States
(12) Patent Application Publication
(10) Pub. No.: US 2018/0022319 A1
(43) Pub. Date: Jan. 25, 2018

(54) WIPER SYSTEM

(71) Applicant: Robert Bosch GmbH, Stuttgart (DE)

(72) Inventors: Achim Hawighorst, Buehlertal (DE); Robert-Jan van de Rovaart, Ottersweier (DE); Andreas Biank, Oberlauterbach (FR); Achim Kraus, Belgrade (RS); Ulrich Metz, Achern (DE); Branislav Milenkovic, Belgrade (RS)

(21) Appl. No.: 15/304,048

(22) PCT Filed: Apr. 16, 2015
(86) PCT No.: PCT/EP2015/058310

§ 371 Date: Oct. 13, 2016

(51) Int. Cl. B60S 1/04; B60S 1/18

(52) U.S. Cl. CPC B60S 1/045; B60S 1/18

(57) ABSTRACT

The invention relates to a method for mounting a wiper system and to a wiper system comprising a first wiper bearing having a first drive shaft for a first wiper arm and a second wiper bearing having a second drive shaft for a second wiper arm, the first and the second drive shafts being non-rotatably connected via a coupling rod. A first retaining means for holding the coupling rod in place on the first wiper bearing is provided in a first defined position and a second retaining means for holding the coupling rod in place on the second wiper bearing is provided in a second defined position.

### BACKGROUND OF THE INVENTION

The invention relates to a wiper system and to a method for mounting a wiper system.

A drive arrangement of a wiper device for the window panes of a motor vehicle is known from the German patent application DE 102 61 926 A1. The drive arrangement comprises two wiper bearings, in which drive shafts for wipers are mounted, the two wiper bearings being connected to one another only by a coupling rod. The coupling rod is non-rotatably connected to the drive shafts of the wiper bearings. The wiper bearings without a bracket have the advantage that said bearings can be manufactured more cost effectively and require less installation space because a bracket is not present.

Furthermore, there are wiper systems in which the wiper bearings are fixedly connected to one another by means of a bracket. These wiper bearings have the advantage that they can easily be mounted precisely to the body of the vehicle.

### SUMMARY OF THE INVENTION

The aim of the invention is to provide a cost effective wiper system which can be precisely mounted to the body of a vehicle.

The aim of the invention is met by means of the wiper system according to the invention and the method for mounting a wiper system according to the invention.

An advantage of the wiper system is that said wiper system can be cost effectively manufactured, is light, requires little installation space and that the two wiper bearings are nevertheless located in a defined position with respect to one another. Hence, the two wiper bearings can be easily mounted on a body of an automobile so as to be precisely aligned with one another. This is achieved by the fact that retaining means are provided that hold the coupling rod in each case in defined positions in relation to the two wiper bearings. After mounting the wiper bearings, the retaining means can be released so that the drive shafts can be moved via the coupling rod.

The retaining means can be manufactured significantly more cost effectively in relation to a bracket known from the prior art that connects the wiper bearings. Moreover, the retaining means require less installation space in the vehicle. The retaining means are furthermore lighter than the console; thus enabling a weight savings to be achieved in the wiper system.

In one embodiment, the first and/or the second retaining means are designed in such a way that a force-fitted and/or positive-locking connection is produced between the first wiper bearing and the coupling rod and/or between the second wiper bearing and the coupling rod. A force-fitted and/or positive locking connection is well suited to holding the coupling rod in a defined position relative to the respective wiper bearing. In addition, a force-fitted and/or positive-locking connection can be easily released after mounting so that the coupling rod can be moved freely with respect to the wiper bearings.

In a further embodiment, the first and/or the second retaining means comprises a predetermined breaking point. With the aid of the predetermined breaking point, the connection between the coupling rod and the wiper bearings can be released by breaking the retaining means after the wiper system has been mounted to the body. The use of the predetermined breaking point has the advantage that the retaining means can be robustly designed and a firm mounting of the coupling rod in relation to the wiper bearing is possible. As a result, a very precise fixing of the coupling rod in relation to the wiper bearing is facilitated. In addition, the retaining means can be easily and cost effectively produced. After mounting, the installer can, for example, break the first and/or the second retaining means at the predetermined breaking point and thus enable the coupling rod to move freely.

In a further embodiment, the first and/or the second retaining means are designed in such a way that the coupling rod, in the mounting position, lies outside of an operating region of the coupling rod during the normal operation of the wiper system. After releasing the retaining means, it is therefore not necessary to remove the retaining means. It is sufficient if the coupling rod is moved into the normal operating region. Depending on the selected embodiment, this can take place manually by an installer or by means of a motor of the wiper system.

In a further embodiment, the first and/or the second retaining means are fixedly connected to the first or respectively to the second wiper bearing. In a preferred manner, the first wiper bearing and the first retaining means and/or the second wiper bearing and the second retaining means can be integrally formed. The integral configuration offers a precise alignment of the wiper bearings in relation to one another. The fixed connection between the retaining means and the wiper bearings has the advantage that more space is available for forming the retaining means at the wiper bearing than at the coupling rod.

In a further embodiment, the first and/or the second retaining means are connected via a releasable force-fitted and/or positive-locking connection to the coupling rod. This has the advantage that, after releasing the retaining means, the coupling rod is free from pieces of the retaining means and is therefore not impaired in the movement thereof nor by an increased weight resulting from the pieces of the retaining means. Hence, the coupling rod can be moved in a low-energy manner during operation of the wiper system. The additional weight, which is caused by the retaining means at the wiper bearing, does not have to be moved and thus does not cost any current during operation of the wiper system.

In a further embodiment, the first and/or the second retaining means have a detent element, with which the retaining means is latched to the first wiper bearing or respectively to the second wiper bearing. The use of a detent element provides a simple and cost effective design of the retaining means and furthermore a simple and cost effective attachment of the retaining element to the coupling rod and/or to the first or respectively to the second wiper bearing. In addition, the detent element can be released with relatively small forces from the coupling rod and/or from the first or respectively the second wiper bearing.

In a further embodiment, the force-fitted connection between the coupling rod and the first or respectively the second wiper bearing is implemented with the help of the first or respectively second retaining means in the form of a force-fitted connection. For example, a magnetic force, an electromagnetic force, an electrostatic force and/or an adhesive force in the form of an adhesive layer can be used as a force. The aforementioned forces are suitable for providing the desired defined position of the coupling rod and the wiper bearing in relation to one another when mounting the wiper system and for releasing the coupling rod from the defined position after mounting. The retaining means, the coupling rod and the wiper bearings are provided with the corresponding materials or respectively layers or devices for forming the electromagnetic, the magnetic and/or the electrostatic force.

In a further embodiment, the force-fitted and/or positive-locking connection is formed such that the connection is released from the mounting position by actuating a motor of the wiper system, which drives the drive shafts, and is preferably moved into an operating position.

In a further embodiment, the first retaining means and/or the second retaining means are attached to the first wiper bearing or respectively to the second wiper bearing. In addition, the first and/or the second retaining means comprise a detent element which, in a mounting position, fixedly holds the coupling rod in the predetermined positions relative to the wiper bearings. In this way, a simple and cost effective configuration of the retaining means is made possible.

The disclosed method has the advantage that the cost effective wiper system can be precisely mounted to the body of a vehicle so as to have a desired position of the wiper bearings in relation to one another, and a normal operation of the wiper bearing is subsequently possible without impairment. This is achieved by virtue of the fact that, after mounting the wiper system, the coupling rod is freed from the defined position by releasing the retaining means and is thus available for a normal operation of the wiper system.

In a further embodiment, the coupling rod is released from the retaining means and said coupling rod is moved into an operating position. This is then advantageous if the position of the coupling rod in the mounting position is located outside of the operating region for an operation of the wiper system. The movement of the coupling rod into the operating position achieves the fact that the remaining retaining means do not impair the normal operation of the coupling rod and thus do not have to be removed.

In a further embodiment, the coupling rod is released from the retaining means with the help of a motor of the wiper system by the wiper system moving a drive shaft and thus the coupling shaft. To this end, a corresponding program is deposited in a control device for actuating the motor of the wiper system. It is thus not necessary that an installer releases the coupling rod from the connection with the retaining means after mounting the wiper system.

### BRIEF DESCRIPTION OF THE DRAWINGS

The invention is explained below with the aid of the figures in the drawings. In the drawings:

FIG. 1 shows a first embodiment of a wiper system in a mounting position;

FIG. 2 shows the first embodiment of the wiper system in an operating region;

FIG. 3 shows a second view of FIG. 1;

FIG. 4 shows a second view of the wiper system in the operating region;

FIG. 5 shows a retaining means which is attached to the wiper bearing in a releasable manner,

FIG. 6 shows a retaining means comprising a predetermined breaking point, which means is integrally formed with the coupling rod and the wiper bearing;

FIG. 7 shows a retaining means which is connected to the coupling rod by means of an adhesive layer;

FIG. 8 shows a retaining means that is connected to the wiper bearing by means of an adhesive layer;

FIG. 9 shows a retaining means that is connected to the coupling rod in a force-fitted manner;

FIG. 10 shows a retaining means that is connected to the wiper bearing in a force-fitted manner;

FIG. 11 shows a retaining means that is connected to the coupling rod in a positive-locking manner; and

FIG. 12 shows a retaining means that is connected to a wiper bearing in a force-fitted manner;

FIG. 13 shows a retaining means which comprises a first and a second detent element that has continuous arms;

FIG. 14 shows a retaining element which comprises a first and a second detent element that has separate arms.

### DETAILED DESCRIPTION

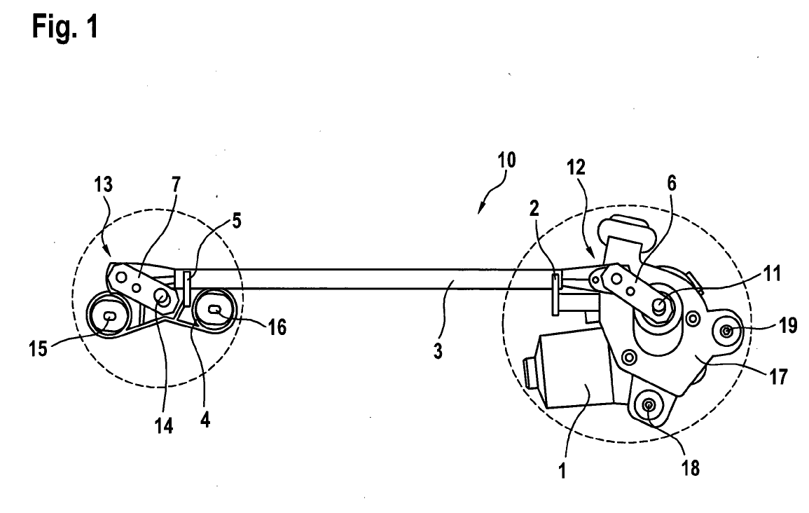

FIG. 1 shows a wiper system 10 in a perspective view, said wiper system comprising a wiper motor 1 which drives a first drive shaft 11 for a non-depicted wiper arm directly or via a transmission. The first drive shaft 11 is connected in a rotationally fixed manner to the non-depicted first wiper arm. In addition, the first drive shaft 11 is connected in a rotationally fixed manner to a crank 6, which is connected by means of a second end thereof to a coupling rod 3 via a first joint 12. The coupling rod 3 is connected at a second end to a bearing plate 7 via a second joint 13. The first and the second joint 12, 13 are designed as pivot joints. The bearing plate 7 is connected with a second end thereof to a second drive shaft 14 in a rotationally fixed manner. The second drive shaft 14 is connected in a rotationally fixed manner to a second wiper arm, which is not depicted. The wiper arms are provided to wipe a window pane of a motor vehicle. The second drive shaft 14 is rotatably mounted in a second wiper bearing 4. The second wiper bearing 4 comprises two attachment means 15, 16 with which the second wiper bearing 4 can be attached at two defined points of the body. In addition, the second wiper bearing 4 comprises a second retaining means 5, with which the coupling rod 3 is held in a second defined position relative to the second wiper bearing 4.

The wiper motor module 1 comprises a first wiper bearing 17 that has a third and a fourth attachment means 18, 19, with which the first wiper bearing 17 can be attached to a defined position on the body. The first wiper bearing 17 furthermore has a first retaining means 2, with which the coupling rod 3 is held in a defined first position relative to the first wiper bearing 17. FIG. 1 shows the wiper system 10 in a mounting position in which the positions of the first and the second wiper bearing 17, 4 are precisely defined relative to one another via the connection of the retaining means 2, 5 to the coupling rod 3. In so doing, the first and the second wiper bearing 17, 4 can be attached with the aid of the attachment means 15, 16, 18, 19 in a defined position relative to one another on the body of the vehicle without a great deal of effort and expense.

In the exemplary embodiment, the attachment means 15, 16, 18, 19 are configured in the shape of holes, which can be fixed via screw connections to the body of the vehicle. Depending on the selected embodiment, at least one or a plurality of the attachment means 15, 16, 18, 19 can be configured in the form of a detent or locking means, which is inserted into a corresponding recess of the body and latched. In addition, detent means can be also be formed on the body of the vehicle, which engage in the corresponding holes 15, 16, 19, 18 of the wiper bearings 17, 4 and thereby attach the wiper system 10 to the body of the vehicle.

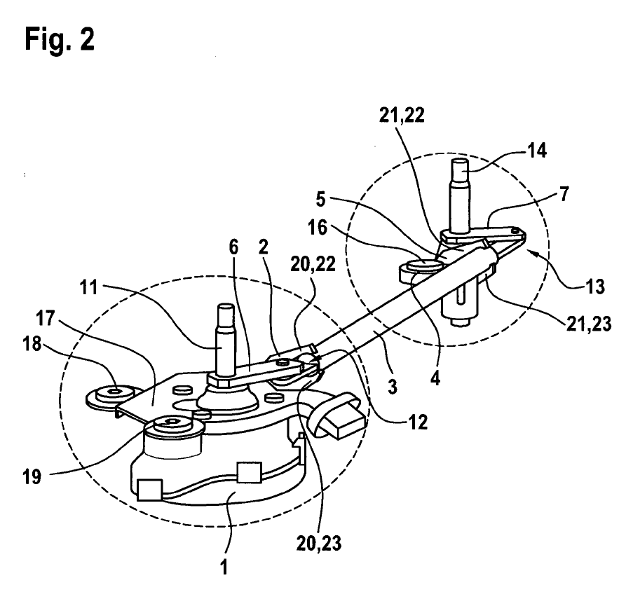

FIG. 2 shows a second view of the wiper system 10 in the mounting position. In the exemplary embodiment depicted, the retaining means 2, 5 are fixedly connected at one end to the corresponding wiper bearing 17, 4 and have a detent element 20, 21 at a second end. The detent elements 20, 21 are configured in the form of two arms 22, 23, which, in the mounting position, fixedly retain the coupling rod 3 at opposite sides. The coupling rod 3 can, for example have a circular cross-section. Accordingly, inner sides of the arms 22, 23 are likewise circularly shaped and the two arms 22, 23 engage over more than a semicircle of the cross-section of the coupling rod 3. Depending on the selected embodiment, the detent elements 20, 21 can also have other shapes.

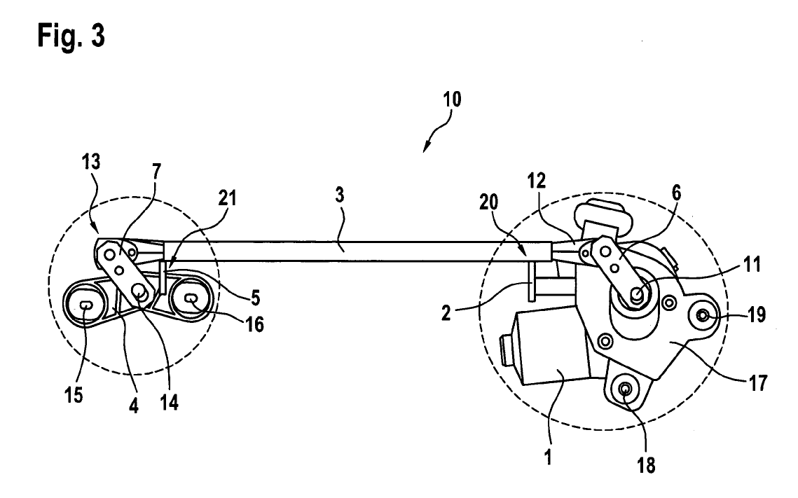

The coupling rod 3 is released by being pulled out of the two detent elements 20, 21, as is depicted in FIG. 3. The coupling rod 3 is now located in a park position, i.e. at the beginning of an operating region. The coupling rod can be pulled by hand out of the detent elements 20, 21 by an installer after mounting the wiper system to the body of the vehicle or can be autonomously pulled out by the wiper motor 1. To this end, the wiper motor 1 is correspondingly actuated by a control unit.

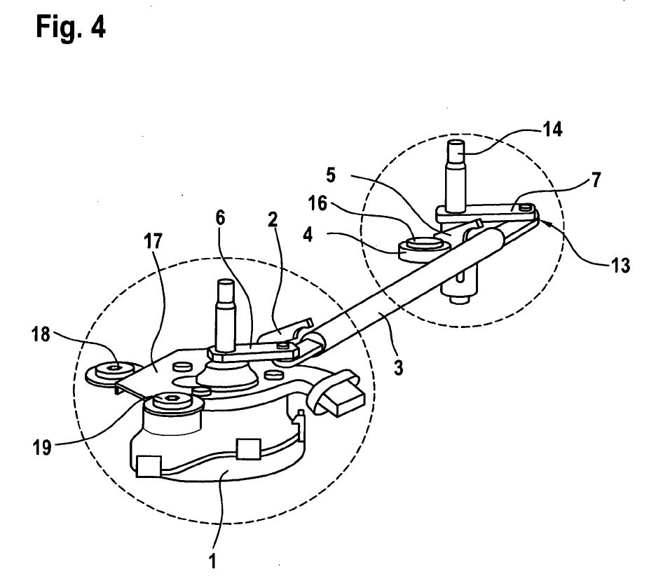

FIG. 4 shows the wiper system 10 of FIG. 3 in a second view, i.e. released from the retaining means 2, 5.

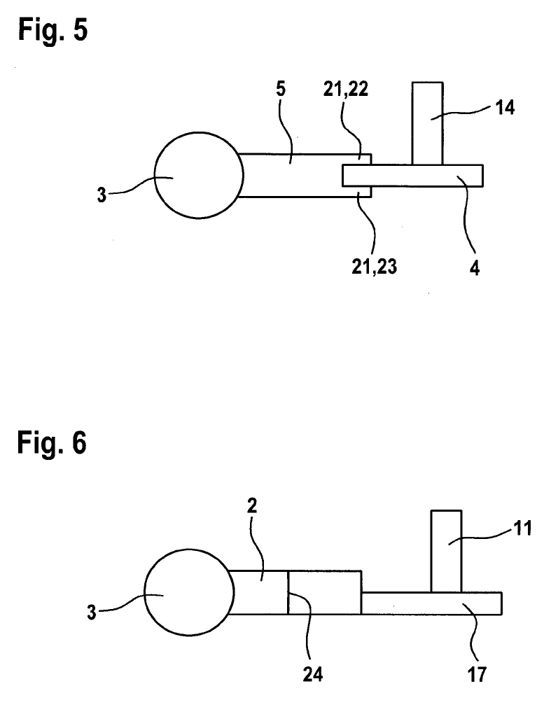

FIG. 5 shows a further embodiment in which the second retaining means 5 is attached to the coupling rod and has a second detent element 21. The coupling rod 3 is only depicted in cross-section. The second detent element 21 is likewise configured in the shape of two arms 22, 23 which engage around the second wiper bearing 4 and fixedly hold the same. The coupling rod 3 can also correspondingly have a first retaining means 2 which is equipped with a first detent element 20 having two arms 22, 23 and is latched to the first wiper bearing 17.

FIG. 6 shows a further embodiment, in which the first retaining means 2 is connected to the coupling rod 3 and to the first wiper bearing 17. The first retaining means 2 has a predetermined breaking point 24 in this embodiment. After mounting, the first retaining means 2 is severed at the predetermined breaking point in order to release the coupling rod 3 from the first wiper bearing 17. The predetermined breaking point 24 can, for example, be configured in the shape of a stiff web strip. Depending on the desired embodiment, the first retaining means 2 can be integrally formed with the coupling rod 3 or with the first wiper bearing 17. In a corresponding manner, the second wiper bearing 4 can be connected to the coupling rod 3 via an analogously designed second retaining means 5, which likewise has a predetermined breaking point 24.

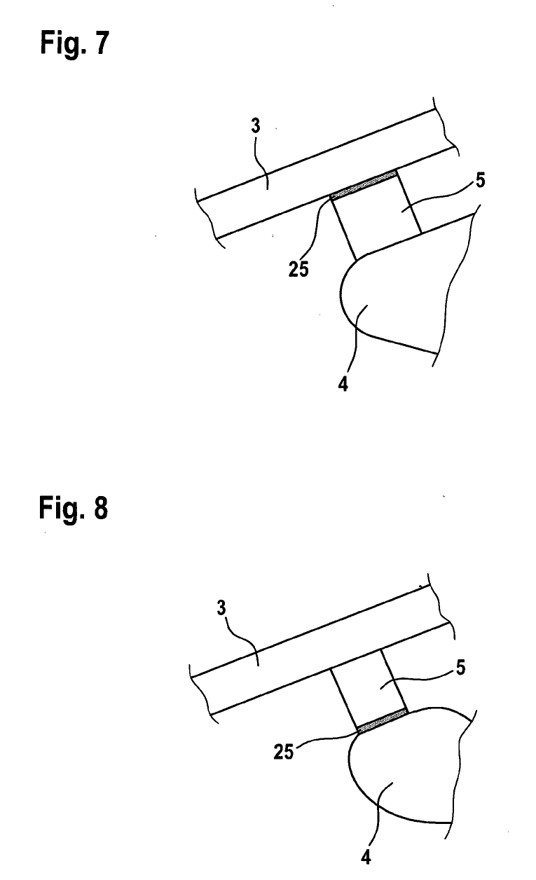

FIG. 7 shows a further embodiment, in which the coupling rod 3 is connected to the second retaining means 5 via an adhesive layer 25, said second retaining means being attached to the wiper bearing 4. The adhesive force of the adhesive layer 25 can be formed in this manner such that an installer or the wiper motor can release the coupling rod 3 from the second wiper bearing 4 by breaking the adhesive layer. In a corresponding manner, the first retaining means 2 can also be connected to the coupling rod 3 via an adhesive layer 25, said first retaining means 2 being attached to the first wiper bearing 17.

FIG. 8 shows a further embodiment, in which the coupling rod 3 is connected to a second retaining means 5, and the second retaining means 5 is attached to the second wiper bearing 4 via an adhesive layer 25. The adhesive layer 25 is correspondingly configured such that an installer or the motor can break the adhesive layer 25 open. The first retaining means 2 can also correspondingly be releasably connected to the coupling rod 3 via a corresponding adhesive layer 25, said first retaining means 2 being fixedly connected to the first wiper bearing 17.

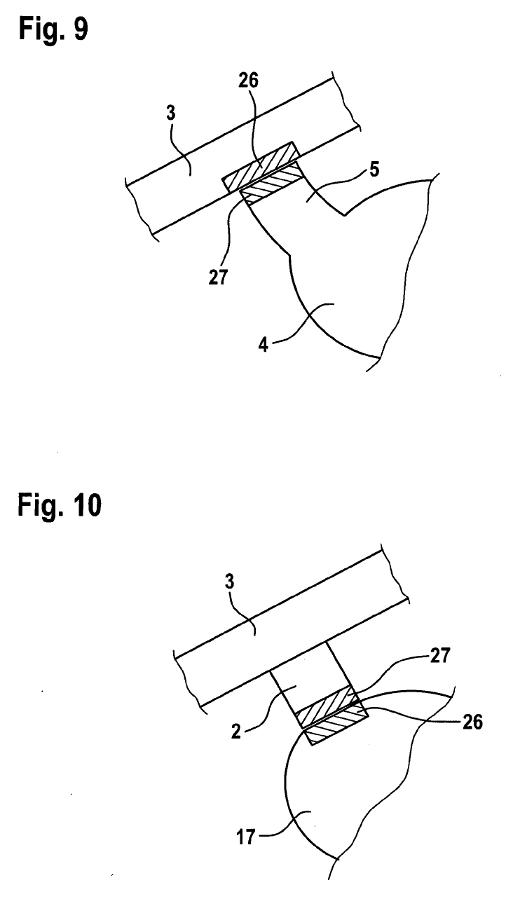

FIG. 9 show a further embodiment, in which the second retaining means 5 is attached to the second wiper bearing 4 and is connected to the coupling rod 3 via an electromagnetic and/or magnetic and/or electrostatic force. To this end, the coupling rod 3 comprises a first layer 26 and the second retaining means 5 a second layer 27. The first and the second layer 26, 27 adjoin one another in the mounting position depicted and are formed in this way such that a magnetic force or an electrostatic force can be produced between the coupling rod 3 and the second retaining means 5. In addition, the first and/or the second layer 26, 27 can also be formed in the shape of coils, which generate an electromagnetic force between the coupling rod 3 and the second retaining means 5 when a corresponding current is passed through said coils. In a corresponding manner, the first retaining means 2 and the coupling rod 3 can have a corresponding first or respectively second layer 26, 27 in the region of the first retaining means 2 and can hold the coupling rod 3 to the first retaining means 2 by means of a magnetic or electrostatic force or an electromagnetic force. In an analogous manner, the first or the second retaining means 2, 5 can also be attached to the coupling rod 3 and be connected to the corresponding wiper bearing 17, 4 by means of a corresponding layer arrangement, as schematically depicted for the first retaining means 2 and the first wiper bearing 17 in FIG. 10.

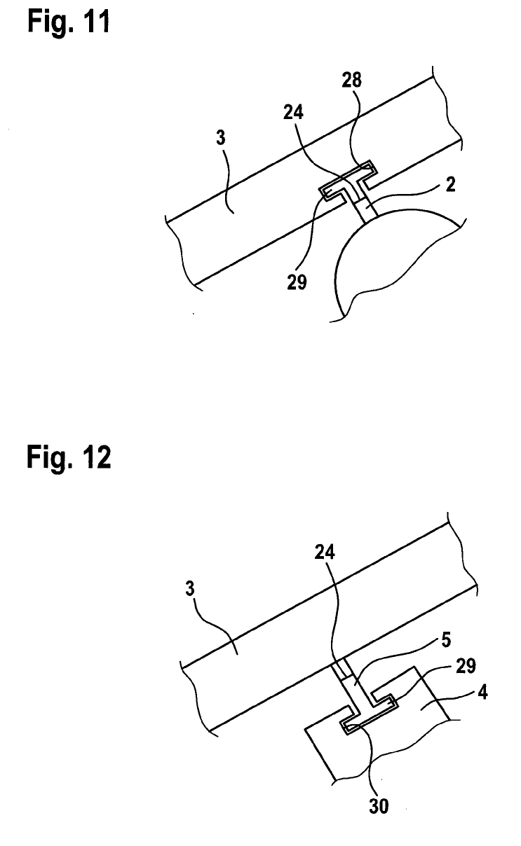

FIG. 11 shows a further embodiment, in which the coupling rod 3 has a detent recess 28, in which a first retaining means 2 comprising a further detent element 29 engages. The detent element 29 is configured as a crossbar in the embodiment depicted, said crossbar being arranged at a free end of the first retaining means 2 transversely to the longitudinal direction of the first retaining means 2. The further detent element 29 can, for example, be of flexible design so that the further detent element 29 can be pulled out of the detent recess 38 when a sufficient force is applied to the coupling rod 3. In addition, the first retaining means 2 can also have a predetermined breaking point, which breaks open when a sufficiently high force is applied to the coupling rod 3. Furthermore, the detent recess 28 can be delimited by flexible walls, which give way at a sufficiently large force and release the further detent element 29. In an analogous manner, the second retaining means 5 can also be correspondingly formed by a further detent element 29 and be connected to the coupling rod 3.

FIG. 12 shows a further embodiment, in which the second wiper bearing 4 has a second detent recess 30. The coupling rod 3 is connected to a second retaining means 5, which has a further detent element 29 at a free end, wherein the further detent element 29 is disposed in the second detent recess 30. The further detent element 29 can correspondingly be of flexible design such that said further detent element 29 is pulled out of the second detent recess 30 when a sufficiently high force is applied to the coupling rod 3. Furthermore, the second retaining means 5 can have a predetermined breaking point 24, which breaks open when a sufficiently high force is applied to the coupling rod 3. The detent recess 28 can furthermore be delimited by flexible walls, which give way when a sufficiently large force is applied thereto and release the detent element 29. The first retaining means 2 can be designed in an analogous manner and be attached to the coupling rod 3 and protrude with a further detent element 29 into a second detent recess 30 of the first wiper bearing 17. The first retaining means 2 can likewise have a corresponding predetermined breaking point 24.

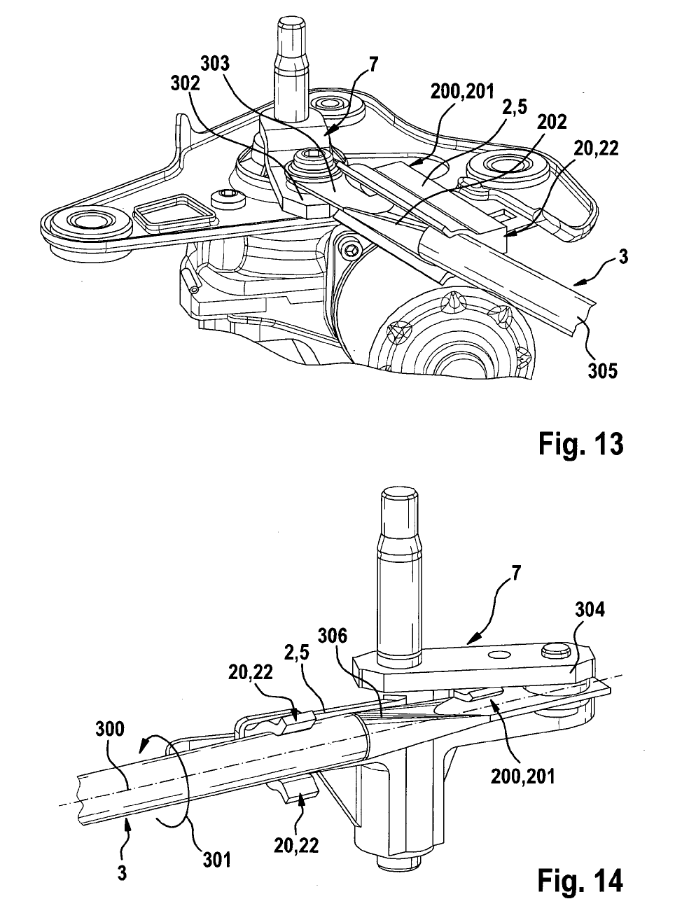

FIG. 13 and FIG. 14 show a wiper system 10, the coupling rod 3 of which is fixed by a retaining element 2, 5, which makes sure that the coupling rod 3 cannot rotate about the main axis 300 thereof in a tangential direction 1. The main axis 300 of the coupling rod 3 extends along the main extension direction of the coupling rod 3, in which the coupling rod 3 extends the furthest. The coupling rod 3 is of tubular design. The coupling rod 3 has flattened regions 303 on the ends thereof; thus enabling a cylindrical portion 305 to be disposed between the regions 303. A transition region 306 is disposed between the region 303 and the cylindrical portion 305, the form of which transition region, starting in the direction of the flat region 303, continuously changes from a cylindrical shape into a flat shape. It is conceivable that the transition region 306 is kept very short so that an abrupt transition is present between the cylindrical portion 305 and the flat region 303. These regions 303 are mounted to the bearing plate 7 and form with the same a joint 304, which is disposed between the bearing plate 7 and the region 303. The joint 304 has play which allows the coupling rod 3 to rotate about the main axis 300 thereof in the tangential direction 301. In order to prevent the rotation, the retaining means 2, 5 comprises not only a part that functions as a detent element 20, which engages around the coupling rod with arms 22 at the cylindrical portion but also a second detent element 200, which engages around the coupling rod 3 in the flat region and thus blocks the degree of freedom in the tangential direction 301. To this end, the second detent element 200 has two arms 201 which engage around the flat region 303, while the detent element 20 engages around the cylindrical portion 305. The arms 22, 201 of the detent elements 20, 200 have on the ends thereof a bend, which is oriented towards the outside, that is to say away from the receiving area 202 in which the coupling rod 3 is disposed. This facilitates the insertion of the coupling rod 3 into the detent element 20, 200. The coupling rod 3 is prevented from rotating by the second detent element 200, the arms 201 of which are straight, thus enabling the flat region 303 to be accommodated free of play. It is also possible for the second detent element 200 to strike against the transition region 306.

The retaining means 2, 5 from FIG. 13 is a one-piece component, the receiving area 202 of which continuously, from one end at which the detent element 20 is located to the other end at which the second detent element 200 is located, adapts to the shape of the coupling rod 3; thus enabling the transition region 303 to likewise be accommodated free of play in the receiving area 202. It is also conceivable that only one region at the end of the retaining element 2, 5 that faces the cylindrical portion 305 is cylindrically formed within the receiving area 202 and thus forms a first detent element; thus enabling the cylindrical portion 305 to be accommodated and that the region at the end of the retaining means 2, 5 that faces the flat region 303 and thus forms a second detent element 200 is formed straight within the recess 202; thus enabling the flat region 303 to be accommodated free of play. A continuous transition is not formed within the receiving area 202 between the two detent elements 20, 200 so that the transition region 306 is not accommodated. As a result, two embodiments are possible. On the one hand, there is the embodiment of FIG. 13, in which the arms 22, 201 are continuous in the axial direction, so that one arm is continuously formed in each case on one side of the coupling rod 3 such that the arms 22, 201 have a one-piece character on one side. In FIG. 14, a second embodiment variant is shown in which the arms 22, 201 of the two detent elements 20, 200 are separate in relation to one another so that the arms 22, 201 do not form a continuous flank on one side. The backside of the retaining means is formed like in the preceding embodiment variants.

Depending on the selected embodiment, the individual embodiments of the described figures can also be combined with one another.

1. A wiper system (10) comprising a first wiper bearing (17) having a first drive shaft (11) configured to be connected to a first wiper arm and a second wiper bearing (4) having a second drive shaft (14) configured to be connected to a second wiper arm, the first drive shaft and the second drive shaft (11, 14) being non-rotatably connected via a coupling rod (3), a first retaining means (2) for holding the coupling rod (3) in place on the first wiper bearing (17) being provided in a first defined position and a second retaining means (5) for holding the coupling rod (3) in place on the second wiper bearing (4) being provided in a second defined position.

2. The wiper system according to claim 1, wherein the first retaining means and/or the second retaining means produces a force-fitted and/or positive-locking connection between the coupling rod (3) and the associated one of the first wiper bearing and the second wiper bearing.

3. The wiper system according to claim 1, wherein the first retaining means and/or the second retaining means has a predetermined breaking point (24).

4. The wiper system according to claim 1, wherein the first defined position and/or the second defined position of the coupling rod (3) lies outside of an operating region of the coupling rod (3) during an operation of the wiper system (10) so that, after the coupling rod (3) has been released, the first retaining means and/or the second retaining means does not interfere with a movement of the coupling rod (3) during an operation of the wiper system (10).

5. The wiper system according to claim 1, wherein the first retaining means and/or the second retaining means is fixedly connected to the associated one of the first wiper bearing and the second wiper bearing.

6. The wiper system according to claim 5, wherein the first retaining means and/or the second retaining means is connected to the coupling rod via a releasable force-fitted and/or positive-locking (25, 26, 27) connection.

7. The wiper system according to claim 2, wherein the first retaining means and/or the second retaining means is a detent element (20, 21, 29) latched to the coupling rod (3) or to the associated one of the first wiper bearing and the second wiper bearing.

8. The wiper system according to claim 2, wherein the force-fitted connection (25, 26, 27) is formed as magnetic force, as electrostatic force and/or as adhesive force in the form of an adhesive layer (25).

9. The wiper system according to claim 2, wherein the force-fitted and/or positive-locking connection is configured such that the coupling rod can be released from the wiper bearings (17, 4) by actuating a wiper motor (1) of the wiper system (10).

10. The wiper system according to one of the claim 1, wherein the first retaining means and the second retaining means are each attached to the associated one of the first wiper bearing and the second wiper bearing, and wherein the first retaining means and the second retaining means (2, 5) each have a respective detent element (20, 21, 29) that holds the coupling rod (3) on the associated wiper bearing (4, 17).

11. The wiper system according to claim 1, wherein at least one of the first retaining means and the second retaining means (2, 5) has a first detent element (20) that accommodates a cylindrical portion (305) and a second detent element (200) that accommodates a flat region (303) of the coupling rod (3) free of play, so that the coupling rod (3) cannot be rotated in the tangential direction (301).

12. The wiper system according to claim 11, wherein at least one of the first retaining means and the second retaining means (2, 5) has a receiving area (202) in the first and second detent elements (20, 200) for the coupling rod (3), said receiving area being formed by two arms (22, 201) configured to engage around the rod (3), wherein the arms (22, 201) of the first detent element (20) and the second detent element (200) are separated from one another or are one piece.

13. A method for mounting a wiper system according to claim 1, wherein the wiper bearings are attached to a body of a vehicle, and wherein the coupling rod is subsequently released from the wiper bearings.

14. The method according to claim 13, wherein the coupling rod is moved into an operating position after being released from a mounting position.

15. The method according to claim 13, wherein the coupling rod is moved by a wiper motor of the wiper system in order to be released.

16. The wiper system according to claim 1, wherein the first retaining means and/or the second retaining means is integrally formed with the associated one of the first wiper bearing and the second wiper bearing.

17. The wiper system according to claim 16, wherein the first retaining means and/or the second retaining means is connected to the coupling rod via a releasable force-fitted and/or positive-locking (25, 26, 27) connection.
